(19) United States
(12) Patent Application Publication
(10) Pub. No.: US 2026/0192944 A1
(43) Pub. Date: Jul. 9, 2026

(54) AIRPORT GATE

(71) Applicant: Oshkosh Corporation, Oshkosh, WI (US)

(72) Inventor: Steve Nestel, Oshkosh, WI (US)

(73) Assignee: Oshkosh Corporation, Oshkosh, WI (US)

(21) Appl. No.: 19/439,236

(22) Filed: Jan. 2, 2026

Related U.S. Application Data
(60) Provisional application No. 63/741,866, filed on Jan. 4, 2025.

(51) Int. Cl. B64F 1/305; B60N 5/00; G07C 9/10; G07C 9/22

(52) U.S. Cl. CPC B64F 1/305; B60N 5/00; G07C 9/10; G07C 9/22

(57) ABSTRACT

An airport gate system includes a bridge, a barrier assembly, a sensor, and a controller. The bridge includes a first end and a second end opposite to the first end. The second end is configured to be coupled to an airplane and the bridge is configured to permit access to a door of the airplane. The barrier assembly is configured to selectively limit movement of a passenger along the bridge. The sensor is configured to acquire data regarding the passenger. The controller is operatively coupled to the barrier assembly and the sensor. The controller is configured to determine whether the passenger is permitted to board the airplane based on the data. In response to a determination that the passenger is not permitted to board the airplane, the controller is configured to control the barrier assembly to limit movement of the passenger along the bridge.

### CROSS-REFERENCE TO RELATED PATENT APPLICATION

This application claims the benefit of and priority to U.S. Provisional Patent Application No. 63/741,866, filed Jan. 4, 2025, which is incorporated herein by reference in its entirety.

### BACKGROUND

Various ground support equipment (“GSE”) are used to prepare and service an aircraft prior to departure. Such preparation involves many moving parts that can cause a hectic scene and lead to accidents between the GSE or with the aircraft.

### SUMMARY

One embodiment relates to an airport gate system. The airport gate system includes a bridge, a barrier assembly, a sensor, and a controller. The bridge includes a first end and a second end opposite to the first end. The second end is configured to be coupled to an airplane and the bridge is configured to permit access to a door of the airplane. The barrier assembly is configured to selectively limit movement of a passenger along the bridge. The sensor is configured to acquire data regarding the passenger. The controller is operatively coupled to the barrier assembly and the sensor. The controller is configured to determine whether the passenger is permitted to board the airplane based on the data. In response to a determination that the passenger is not permitted to board the airplane, the controller is configured to control the barrier assembly to limit movement of the passenger along the bridge.

Another embodiment relates to an airport gate system. The airport gate system includes a bridge, a display, a sensor, and a controller. The bridge is configured to permit access to a door of an airplane. The display is coupled to the bridge and positioned to be visible to a passenger passing along the bridge. The sensor is configured to acquire data regarding the passenger. The controller is operatively coupled to the display and the sensor. The controller is configured to identify a customer profile of the passenger based on the data and control the display to present content based on the customer profile of the passenger.

Another embodiment relates to an airport gate system. The airport gate system includes a terminal section, a bridge, a barrier assembly, a sensor, and a controller. The bridge extends outward from the terminal section and is configured to permit access to a door of an airplane. The barrier assembly is coupled to the terminal section and configured to selectively limit movement of a passenger along the bridge. The sensor is configured to acquire data regarding the passenger. The controller is operatively coupled to the barrier assembly and the sensor. The controller is configured to determine whether the passenger is permitted to board the airplane based on the data. In response to a determination that the passenger is permitted to board the airplane, the controller is configured to control the barrier assembly to permit movement of the passenger along the bridge.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a schematic representation of a GSE coordination system, according to an exemplary embodiment.

FIG. 2 is a schematic representation of GSE used to service or support an airplane and airport operations, according to an exemplary embodiment.

FIG. 3 is a schematic representation of the GSE of FIG. 2 in communication via a server, according to an exemplary embodiment.

FIG. 4 is a perspective view of an airport gate, according to an exemplary embodiment.

FIG. 5 is a side section view of the airport gate of FIG. 4.

FIG. 6 is a front view of the airport gate of FIG. 4.

FIG. 7 is a block diagram of a control system for an airport gate, according to an exemplary embodiment.

FIG. 8 is a flowchart of a method of operating a gate control system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, an airport gate permits boarding and deplaning of passengers with respect to an airplane. The gate includes a bridge connecting the airplane to a terminal, and the passengers may move along the bridge to pass between the airplane and the terminal. The airport gate includes an identity sensor configured to acquire identity data of a passenger attempting to pass along the bridge. The identity data may uniquely identify each passenger, such that the identity data indicates the identity of the passenger. Using the identity data, a controller may determine whether the passenger is permitted to board the airplane. If the controller determines that the passenger is not permitted to board the airplane, the controller may control a barrier to prevent the passenger from passing along the bridge. The bridge is outfitted with a series of displays along the length of the bridge. The controller may use the identity data to identify a customer profile associated with the passenger. Based on the customer profile, the controller may select content to display on the displays as the customer moves along the bridge.

### GSE Coordination System

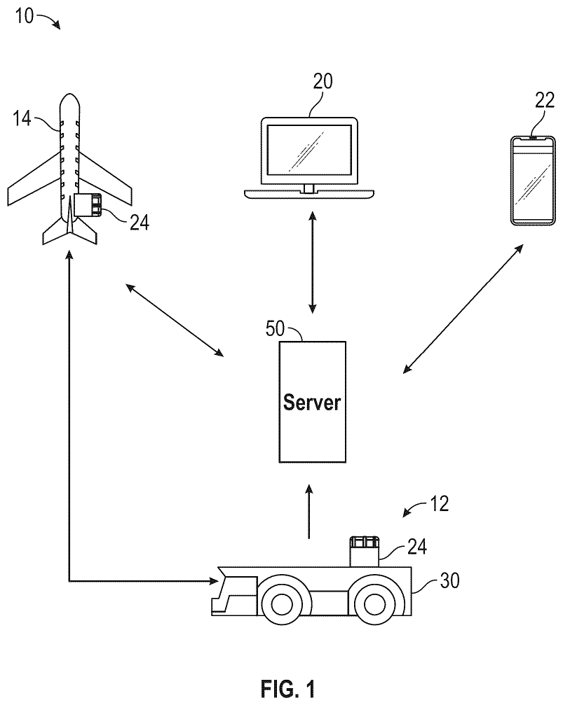

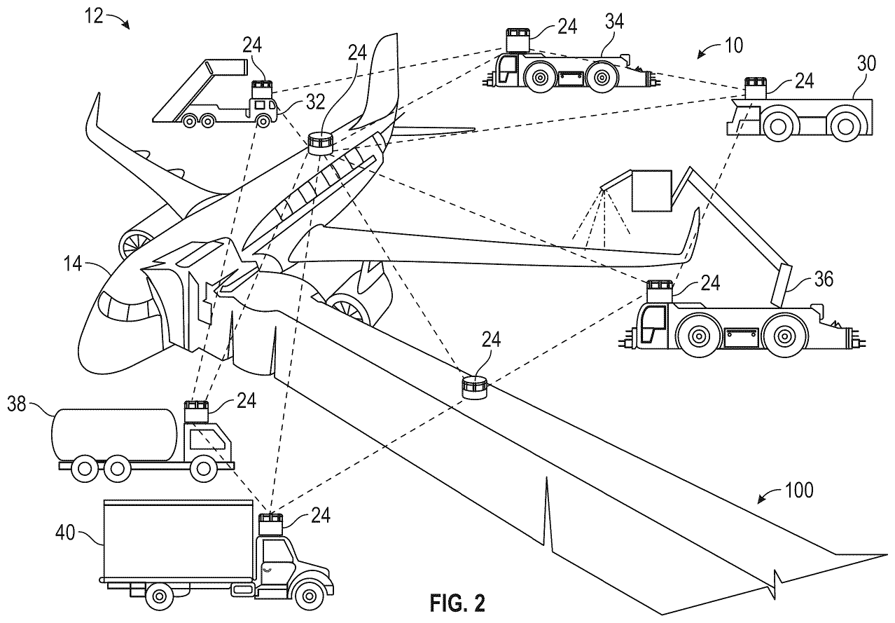

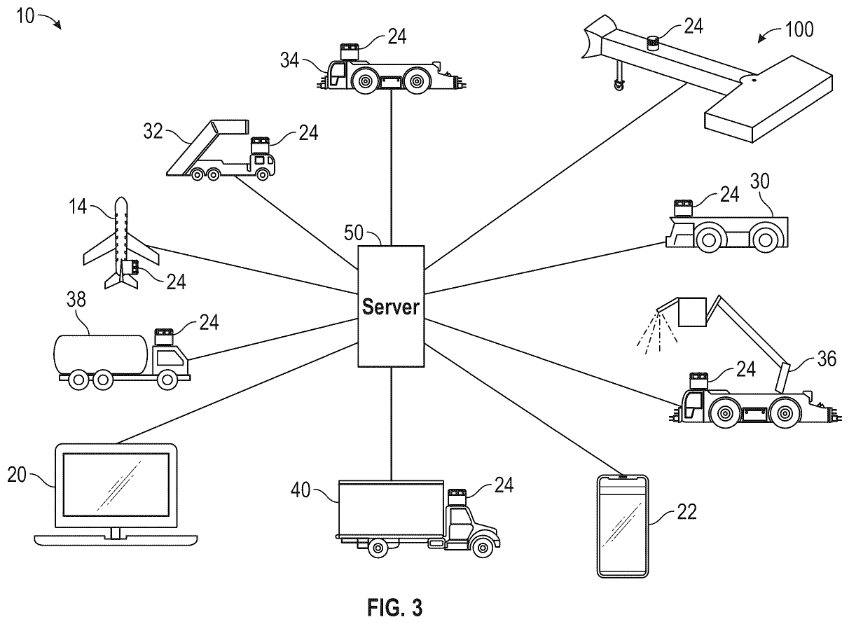

As shown in FIGS. 1-3, a vehicle coordination system, shown as GSE coordination system 10, is used to coordinate motion and procedures of vehicles, machines, and/or equipment, shown as GSE 12, used to service or support an aircraft, shown as airplane 14, and airport operations. The GSE coordination system 10 includes a node or portal 20, a user device 22, beacon(s) 24, the airplane 14, and the GSE 12. Referring to FIG. 1, the GSE 12 includes a tow vehicle (e.g., an aircraft tow vehicle, a tow-bar-less tow vehicle, an aircraft tractor, etc.), shown as tractor 30, with a beacon 24 coupled thereto. Although the GSE 12 is shown in FIG. 1 to include only the tractor 30 and the beacon 24, it should be appreciated that the GSE coordination system 10 may be used to facilitate communication between any of the GSE 12 used during service or support of the airplane 14 and airport operations (e.g., any of the plurality of vehicles shown in FIGS. 2 and 3). For example, the service or support of the airplane 14 and the airport operations may include any of passenger boarding, bridge docking, cargo loading/unloading, baggage loading/unloading, pushback, towing, de-icing, food delivery, fueling, etc. Accordingly, as shown in FIGS. 2 and 3, the GSE 12 can include any of the tractor 30, a cargo loader 32, a baggage tractor 34, a de-icing truck 36, a fueling truck 38, a food delivery truck 40, and/or an airport gate 100 (e.g., including a boarding bridge), among other possible GSE used to service or support the airplane 14 and airport operations. The GSE 12 may each include corresponding controllers, sensors, user interfaces, etc.

As described above, the tractor 30 is used for one or more operations at an airport including pushing the airplane 14 during pushback operations (e.g., departing from the airport gate 100), towing the airplane 14 between locations (e.g., between gates, hangars, fueling areas, maintenance areas, de-icing areas, etc.), positioning the airplane 14 (e.g., into proper alignment at a gate with a bridge), and/or other operations. The cargo loader 32 is used to load and unload cargo, baggage, freight, etc., onto and off of the airplane 14. For example, the cargo loader 32 may include an extendable portion configured to reach a storage opening of the airplane 14 such that airport personnel and/or another facilitator of an aircraft servicing process can load cargo, baggage, freight, etc. onto the airplane 14 through the storage opening.

The baggage tractor 34 is used to transport cargo, baggage/baggage carts, freight, etc., around an airport during the aircraft servicing process. For example, the baggage tractor 34 may be used to transport baggage from the airplane 14 (e.g., baggage that was unloaded from the airplane 14 using the cargo loader 32) to a baggage claim at an airport terminal. The de-icing truck 36 is used to remove snow, ice, frost, etc. from the airplane 14 (e.g., from the wings, fuselage, control surfaces, etc.) prior to takeoff. The fueling truck 38 transports fuel between locations (e.g., from a fueling station to a departure gate) and provides the fuel to the airplane 14. The food delivery truck 40 is used to transport food, beverages, and other in-flight service items to the airplane 14. The food delivery truck 40 may arrive at the gate of the airplane 14 prior to takeoff to ensure that the airplane 14 is stocked with enough food, beverages, and other supplies to sustain passengers for a duration of an upcoming flight. The airport gate 100 is a covered walkway that connects the airplane 14 to an airport terminal. The airport gate 100 therefore allows passengers to enter the airport terminal from the airplane 14 without having to go outside or use stairs. In some implementations, the airport gate 100 is replaced with or supplemented by a stair truck.

As shown in FIGS. 1-3, the beacons 24 may be coupled to each of the GSE 12 and/or to the airplane 14. The beacons 24 may facilitate the coordination of the GSE 12 by transmitting data/information relating to the GSE 12 and/or the airplane 14 (e.g., a location, an operational status, an order of tasks in a servicing procedure, etc.) over the GSE coordination system 10 (e.g., via a server 50, directly between the beacons 24, etc.). For example, as shown in FIG. 1, data/information relating to the airplane 14 and the tractor 30 may be communicated via the server 50 and/or directly between the beacons 24 such that motion of the airplane 14 and the tractor 30 may be coordinated based on the data/information communicated over the GSE coordination system 10. That is, the coordination may include tracking a location of the tractor 30 relative to the airplane 14 via the beacons 24 such that the tractor 30 does not hit the airplane 14 (e.g., during approach for pushback operations). In some embodiments, the data/information is communicated via the server 50 to the node or portal 20 and/or to the user device 22 such that the motion of the airplane 14 and/or the tractor 30 is coordinated via the node or portal 20 and/or the user device 22. For example, a remote user may control one or more functions of the tractor 30 via the user device 22. As another example, the node or portal 20 may be configured to automatically initiate one or more functions of the tractor 30 based on the data/information communicated using the GSE coordination system 10. In embodiments where the beacons 24 communicate directly with one another rather than via the server 50 (e.g., as shown in FIG. 2), the beacons 24 are configured to communicate with each other via a mesh communication network.

As shown in FIGS. 1 and 3, the GSE coordination system 10 may be configured to communicate information from each of the beacons 24 of the GSE 12 via the server 50. For example, the server 50 may be configured to facilitate operator access to dashboards including data regarding the airplane 14, the tractor 30, the cargo loader 32, the baggage tractor 34, the de-icing truck 36, the fueling truck 38, the food delivery truck 40, and/or the airport gate 100 to manage and operate the tractor 30. In some embodiments, however, the processes described herein to manage and operate the tractor 30 is similarly performed to manage and operate any of the GSE 12. That is, the server 50 may be used to coordinate the motion of the GSE 12 by communicating the motion, status, condition, etc. of the plurality of vehicles included in the GSE 12 and the airport gate 100 amongst each other. For example, each of the plurality of vehicles and the airport gate 100 included in the GSE 12 may include sensors (e.g., proximity sensors, position sensors, cameras, etc.). Data from the sensors relating to each vehicle included in the GSE 12 may be communicated to other vehicles in the GSE 12 from the beacons 24 via the server 50 to coordinate the motion of the GSE 12.

Based on the data relating to the GSE 12 communicated via the server 50 (as shown in FIGS. 1 and 3) and/or the mesh communication network (e.g., as shown in FIGS. 1 and 2), the GSE coordination system 10 may be further configured to coordinate the motion of each of the plurality of vehicles included in the GSE 12. In some embodiments, the beacons 24 provide signals to at least one of the airplane 14, the node or portal 20, the user device 22, the tractor 30, the airport gate 100, and/or another observer. The signals indicate a status or condition of a vehicle (e.g., power on, power off, in operation, fuel level, electrical system state of charge, diagnostic trouble codes (DTC), maintenance required, location, speed, direction of travel, etc.). In some embodiments, the status or condition is communicated via the server 50. In some embodiments (e.g., when providing a signal to an observer), the beacon 24 is a vehicle component. In other embodiments, the beacon 24 is a separate device attached to the vehicle (e.g., a vehicle external light, a vehicle internal light, etc.). The beacon 24 may include a light (e.g., an incandescent light, a LED, a fixed beacon, a flashing beacon, a rotating beacon, a laser, a light array, etc.), a display device, a marker, etc. In some examples, the beacon 24 incorporates an audible indicator of a vehicle status or condition.

The beacon 24 may be configured to generate a variety of visual signals. In some examples, the variety of visual signals comprises one or more colors, patterns, and combinations of colors and patterns. In some examples, the beacon 24 is configured to generate visual signals observable as a light or one or more light patterns. In some examples, the light patterns generated by the beacon 24 can be varied in any optical characteristic (e.g. color, wavelength, intensity, pulse duration, direction, etc.). The visual signals generated by the beacon 24 show various states, conditions, and criteria of the GSE 12 to which the beacon 24 is coupled (e.g., the airplane 14, the tractor 30, the airport gate 100, any of the other GSE 12 depicted in FIGS. 2 and 3, etc.). The visual signals may indicate, for example, that one or more vehicles involved in the aircraft servicing process have completed a designated task. In other examples, the visual signals generated by the beacon 24 indicate predefined or user configurable vehicle conditions for the local identification of that condition. For example, a fueling truck (e.g., fueling truck 38) may cause the beacon 24 to emit a visual signal indicating that it requires a refill of fuel. In some embodiments, the visual signal is initiated in response to a command entered by any of a user of the user device 22, a remote user command, a vehicle-to-vehicle command, a condition or state detected by a sensor of the GSE 12, or a controller logic determination.

In some embodiments, the vehicle sensors detect a state or condition of a vehicle (e.g., the GSE 12). The GSE coordination system 10 determines a command via the server 50 and/or directly via the GSE 12 (e.g., via the mesh communication network) for the beacon 24 to display one or more visual signals. In some embodiments, the beacon 24 illuminates a colored light signal corresponding to the vehicle state or condition. For example, a GSE supervisor may select green to indicate that a vehicle in the GSE 12 has completed its respective task, and yellow to indicate that a vehicle in the GSE 12 is in the process of completing its respective task. In another example, a service technician may transmit a wireless command to all vehicles included in the GSE 12 to flash a red light if the server 50 and/or the beacons 24 receives an indication of a malfunction of any vehicle included in the GSE 12. In some embodiments, motion of a remainder of the GSE 12 may be coordinated based on the signal transmitted by the beacon 24 of a particular component of the GSE 12. For example, in response to a signal from one component of the GSE 12 that the one component is in the process of completing its respective task, the remainder of the GSE 12 may be programmed (e.g., remotely via the node or portal 20 and/or user device 22, locally via a controller located internal to the GSE 12, etc.) to perform respective tasks in a particular order following the completion of the task by the one component of the GSE 12. In some embodiments, each of the respective tasks is automatically initiated according to the particular order.

Each of the plurality of vehicles included in the GSE 12 may be configured to respond to a signal received from the beacons 24 and/or to the information received via the server 50 by coordinating motion/operation accordingly. For example, the signal and/or the information may include location information, movement information, task status or progress information, etc. of one or more other vehicles in the GSE 12. Based on the location information, movement information, task status or progress information, etc., the remainder of the vehicles in the GSE 12 may be configured to coordinate movement to avoid collisions with and/or obstructions to the one or more other vehicles during aircraft servicing and to perform the servicing in the most efficient manner possible.

In some embodiments, operational assistance is provided (e.g., to an operator via an operator interface of the GSE 12 or a user device 22, etc.) to direct the GSE 12 on specific paths to perform respective tasks during the aircraft servicing process without obstructing any other vehicles in the GSE 12. Additionally or alternatively, the operational assistance is provided with instructions regarding when a respective vehicle in the GSE 12 can perform its respective task and/or move around the airplane 14 without obstructing other vehicles and/or in accordance with an aircraft servicing plan, strategy, or protocol. In some embodiments, instructions are provided to a user/operator of a respective vehicle of the GSE 12 and/or personnel involved in the aircraft servicing (e.g., via the operator interface, the user device 22, etc.). In some embodiments, the instructions are configured to cause a respective vehicle of the GSE 12 to autonomously or semi-autonomously operate according to the instructions (e.g., the vehicle may automatically embark on the designated path, automatically move at a time specified by the instructions, perform an instructed task, etc.). The operational assistance may be further configured to prevent movement/operation of a vehicle in response to the signal received from the beacon 24 and/or to the information received via the server 50. In some embodiments, a vehicle in the GSE 12 may be locked, turned off, and/or otherwise prevented from moving/operating in a vicinity of another vehicle in the GSE 12. For example, the baggage tractor 34 may be prevented from moving proximate the airplane 14 while the de-icing truck 36 is in operation.

Accordingly, the GSE coordination system 10 is configured to coordinate the various airport operations of the GSE 12 that need to be performed to service and prepare an aircraft for a flight (e.g., including passenger boarding, bridge docking, cargo loading/unloading, baggage loading/unloading, pushback, towing, de-icing, food delivery, fueling, etc.), thereby facilitating efficient servicing of the aircraft. Such coordination may cause the GSE 12 to follow certain paths to facilitate collision avoidance and facilitate efficient movements, perform tasks at certain designated times according to a servicing protocol (e.g., certain tasks may need to be performed before others), and minimize the amount of time necessary to service the aircraft by continuously monitoring task progress and understanding where and when each vehicle of the GSE 12 should be at all times. In some embodiments, the vehicle-to-vehicle mesh network communication via the beacons 24 is utilized to coordinate motions between the GSE 12 for collision avoidance purposes, while the server 50 manages the overall aircraft servicing plans and transmits task specific instructions to each GSE 12 (e.g., a certain path to take, a certain time to start task, etc.). The GSE coordination system 10 may, therefore, minimize the amount of time required to service an aircraft, allowing more flight departures to be on time and leading to enhanced customer satisfaction. Furthermore, the GSE coordination system 10 may prevent or minimize collisions between the GSE 12 and/or with the airplane 14, reducing vehicle/aircraft downtime and repair/maintenance expenses.

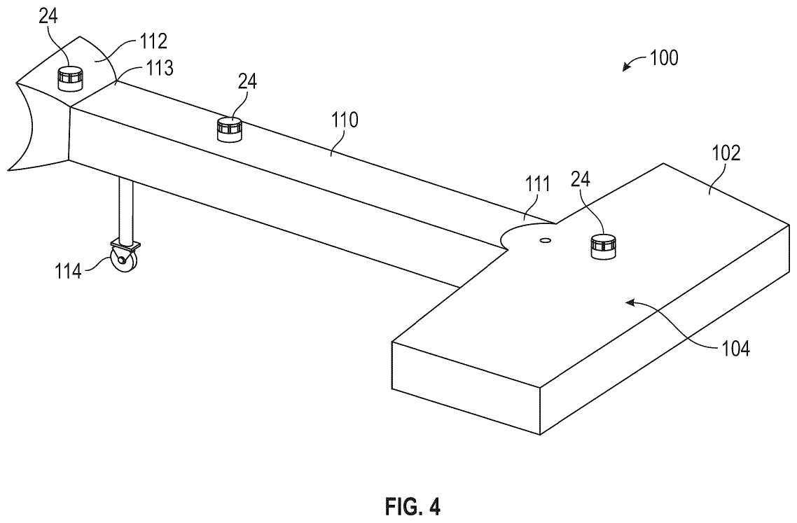

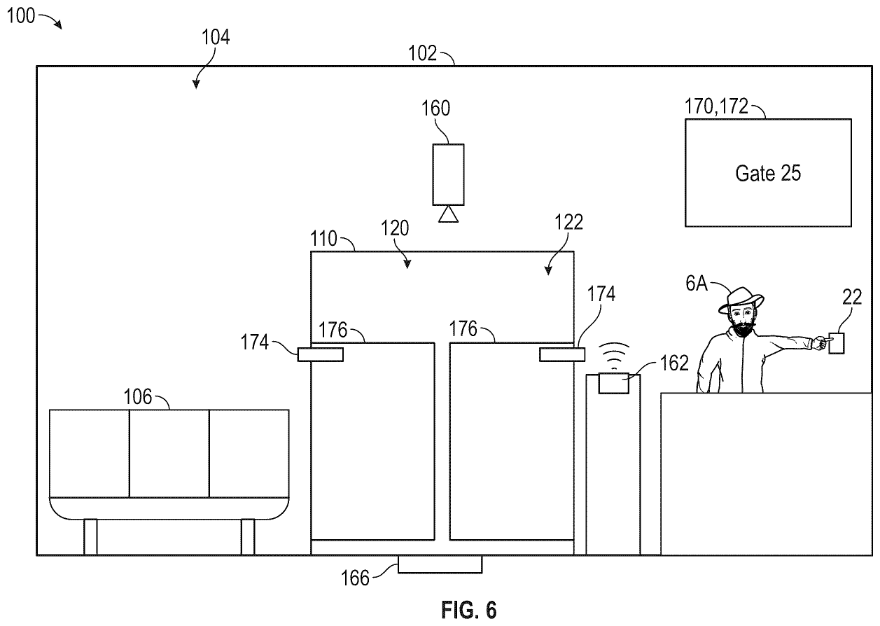

Referring to FIGS. 4-7, the airport gate 100 is shown according to an exemplary embodiment. As shown in FIG. 4, the airport gate 100 includes a building, structure, or portion of a terminal building, shown as terminal section 102. The terminal section 102 may define an area, shown as waiting area 104, within which passengers are permitted to remain before boarding an airplane 14 and after deplaning an airplane 14. The waiting area 104 may contain one or more seats or rest structures (e.g., chairs, benches, lounges, etc.), shown in FIG. 6 as chairs 106, upon which the passengers may choose to rest while waiting to enter the airplane 14.

The airport gate 100 further includes a jetty or abridge, shown as boarding bridge 110. The boarding bridge 110 includes a first end (e.g., a proximal end), shown as first end 111. The first end 111 is coupled to the terminal section 102 such that the boarding bridge 110 extends outward from the terminal section 102. The airport gate 100 further includes a fuselage connection, shown as airplane interface 112, that is configured to engage the airplane 14. The boarding bridge 110 includes a second end (e.g., a distal end), shown as second end 113, that is positioned opposite to the first end 111. The second end 113 is coupled to the airplane interface 112. Accordingly, when the airport gate 100 is connected to an airplane 14, the boarding bridge 110 and the airplane interface 112 extend between the terminal section 102 and the airplane 14. A beacon 24 may be coupled to the terminal section 102, the boarding bridge 110, and/or the airplane interface 112.

The boarding bridge 110 may be repositionable relative to the terminal section 102. By way of example, the boarding bridge 110 may be repositioned (e.g., rotated, expanded, retracted, etc.) relative to the terminal section 102 to facilitate alignment of the airplane interface 112 with a door of the airplane 14. The airport gate 100 includes a series of actuators (e.g., hydraulic cylinders, electric motors, etc.), shown as bridge actuators 114, that move the boarding bridge 110 relative to the terminal section 102. By way of example, the bridge actuators 114 may include an electric motor that drives one or more wheels that engage the ground and propel the boarding bridge 110 in a desired direction.

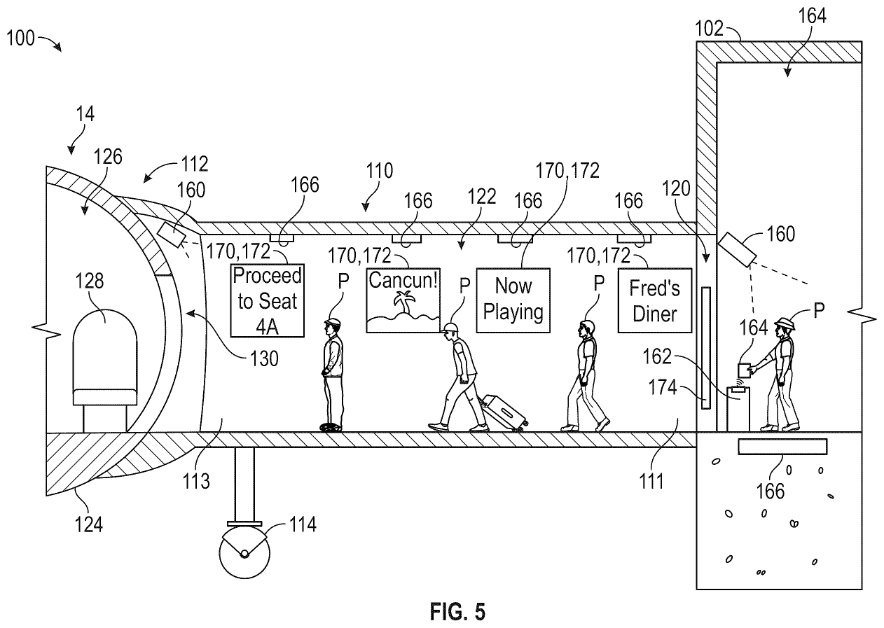

Referring to FIGS. 5 and 6, an interior of the airport gate 100 is shown according to an exemplary embodiment. The terminal section 102 defines a doorway, aperture, or passage, shown as terminal doorway 120, that connects the waiting area 104 to the boarding bridge 110. The boarding bridge 110 and the airplane interface 112 together define an inner volume, shown as hallway 122. The hallway 122 is connected to terminal doorway 120 at a first, proximal end, and to the airplane 14 at a second, distal end. The airplane 14 includes a cylindrical body, shown as fuselage 124, that contains an inner volume, shown as passenger compartment 126, of the airplane 14. The passenger compartment 126 contains one or more seats or rest structures (e.g., chairs, benches, lounges, etc.), shown as chairs 128, that support the passengers when riding within the airplane 14. The fuselage 124 further defines a doorway, aperture, or passage, shown as airplane doorway 130, that permits access to the passenger compartment 126. The airplane interface 112 may be curved and/or flexible to conform the airplane interface 112 to the exterior shape of the fuselage 124. In operation, the bridge actuators 114 may force the airplane interface 112 into engagement with the fuselage 124, such that the airplane interface 112 surrounds the airplane doorway 130. By conforming the airplane interface 112 to the shape of the fuselage 124, the airplane interface 112 may form a seal around the airplane doorway 130 and prevent outside air that is not climate controlled (e.g., cold air, hot air, humid air, etc.) from entering the hallway 122.

Passengers may enter and exit the airplane 14 through the boarding bridge 110. Upon receiving permission to enter the airplane 14, the passengers may pass from the waiting area 104 of the terminal section 102, through the terminal doorway 120, along the hallway 122, and into the passenger compartment 126 through the airplane doorway 130. Once inside the passenger compartment 126, each passenger may find a chair 128 assigned to them (e.g., when purchasing a plane ticket). Similarly, upon receiving permission to exit the airplane 14, the passengers of may pass from the passenger compartment 126, through the airplane doorway 130, along the hallway 122, through the terminal doorway 120, and into the terminal section 102.

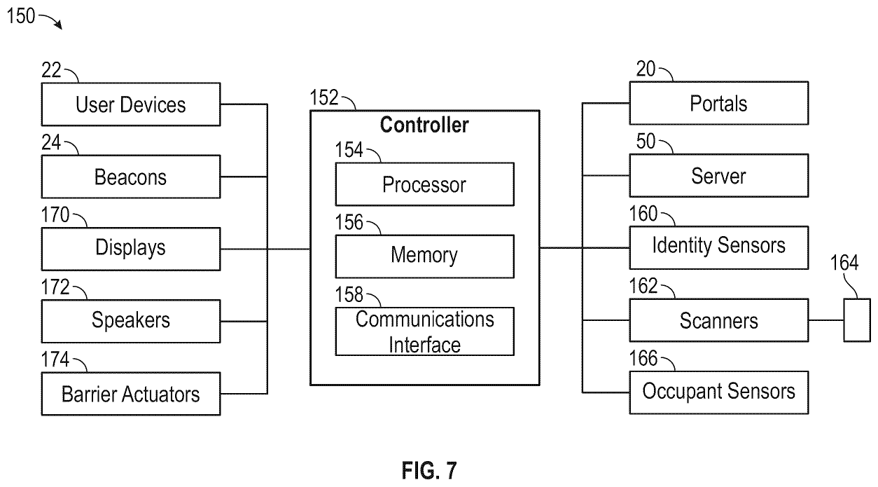

Referring to FIG. 7, the GSE coordination system 10 includes a boarding and deplaning control system, shown as gate control system 150. The gate control system 150 may control operation of the airport gate 100. The gate control system 150 includes a controller 152 that may receive data from and control operation of other components of the gate control system 150. The controller 152 includes a processing circuit, shown as processor 154, a memory 156, and a communications interface 158. The memory 156 may contain one or more instructions that, when executed by the processor 154, cause the controller 152 to execute the processes described herein. The communications interface 158 may facilitate communication between the controller 152 and the other components of the gate control system 150 (e.g., the server 50, the user device 22, etc.).

Referring to FIGS. 5-7, the gate control system 150 includes one or more sensors (e.g., fingerprint sensors, facial recognition sensors, retina sensors, iris sensors, a microphone for voice recognition, etc.), shown as identity sensors 160, operatively coupled to the controller 152. The identity sensors 160 are configured to acquire identity data regarding an individual (e.g., a fingerprint, a facial image, a retina image, an iris images, a voice sample, etc.) and to transmit the identity data to the controller 152. The controller 152 may use the identity data to determine the identity of the individual (e.g., by comparing the identity data to a database containing corresponding data of known individuals). According to the exemplary embodiment shown in FIGS. 5-7, the identity sensors 160 are cameras. The cameras capture images (e.g., still images, video) and provide image data regarding the captured images. As shown, a camera is positioned within the terminal section 102 and positioned to capture an image of an individual, shown as passenger P, that is attempting to pass through the terminal doorway 120 into the hallway 122. The camera may capture image data showing the face, eyes, torso, and/or legs of the passenger P. Accordingly, the image data may be used to identify the passenger P. In other embodiments, the identify sensors 160 additionally or alternatively include biometric sensors (e.g., fingerprint/hand scanners, retina scanners, facial scanners, etc.).

The gate control system 150 further includes one or more sensors, shown as scanners 162, operatively coupled to the controller 152. The scanners 162 may be configured to retrieve identification information (e.g., passenger identity data, boarding pass data, etc.) from a credential 164 associated with the passenger P. The credential 164 may provide the identification information visually (e.g., with a barcode, as text, etc.). By way of example, the credential 164 may include a sheet of paper with the identification information printed onto the sheet of paper or a user device (e.g., a smartphone) that displays the identification information on a screen. Alternatively, the credential 164 may otherwise provide the identification information (e.g., through near field communication or radio frequency identification, by playing a particular sound, etc.).

The scanners 162 may include any type of reader that is capable of retrieving the identification information from the credential 164. By way of example, the scanners 162 may include a camera or barcode scanner that captures an image of the credential 164 or reads a visual identifier of the credential 164. By way of another example, the scanners 162 may include an antenna or other communication interface that is capable of wirelessly communicating with the credential 164. By way of another example, the scanners 162 may include a microphone that is capable of recording sound provided by the credential 164.

The identification information may include information that uniquely identifies the passenger P. By way of example, the identification information may include a name, address, phone number, identification number (e.g., a ticket number, social security number, known traveler number, etc.), and/or other information. The identification information may include information about an intended trip of the passenger P (e.g., a trip associated with a ticket issued to the passenger P). By way of example, the identification information may include a flight number, a departure location (e.g., city, airport, terminal, gate, etc.), a departure time, an arrival location (e.g., city, airport, terminal, gate, etc.), an arrival time, a seat number, or other information.

The gate control system 150 further includes one or more sensors, shown as occupant sensors 166, operatively coupled to the controller 152. The occupant sensors 166 are configured to detect the position and/or movement of passengers P within the airport gate 100. By way of example, the occupant sensors 166 may detect the positions of passengers P along the hallway 122 or the movement of passengers P along the hallway 122. The occupant sensors 166 may include ultrasonic sensors or LiDAR sensors that detect the proximity of objects to predetermined locations along the hallway 122. The occupant sensors 166 may include weight sensors that measure the weight supported at different positions along the length of the hallway 122. The occupant sensors 166 may include one or more cameras that visually identify the positions of the passengers P within the hallway 122. Additionally or alternatively, the occupant sensors 166 may include other types of sensors.

The gate control system 150 further includes one or more visual output devices, shown as displays 170, operatively coupled to the controller 152. The displays 170 may be controlled by the controller 152 to visually communicate information to the passengers P. By way of example, the displays 170 may include liquid crystal displays, light-emitting diode displays, or other types of displays. The displays 170 may be positioned throughout the airport gate 100. As shown, a display 170 is present in the waiting area 104, and several displays 170 are positioned at regular intervals along the hallway 122 such that the displays 170 are visible to the passengers P passing along the hallway 122.

The gate control system 150 further includes one or more audible output devices, shown as speakers 172, operatively coupled to the controller 152. The speakers 172 may be controlled by the controller 152 to audibly communicate information to the passengers P. The speakers 172 may be positioned throughout the airport gate 100. As shown, several speakers 172 are positioned at regular intervals along the hallway 122.

The gate control system 150 further includes a barrier assembly. The barrier assembly may be coupled to the terminal section 102 and positioned between the first end 111 and the terminal section 102. The barrier assembly includes a series of actuators (e.g., electric linear actuators, pneumatic cylinders, electric motors, etc.), shown as barrier actuators 174. The barrier assembly further includes a set of doors, shown as barriers 176. The barrier actuators 174 are coupled to the barriers 176. The barriers 176 are positioned to extend across the terminal doorway 120. The barrier actuators 174 are configured to reposition the barriers 176 between (a) a closed position (shown in FIG. 6) in which the barriers 176 extend across the terminal doorway 120 to prevent passengers P from passing through the terminal doorway 120 and into the hallway 122 and (b) an open position in which the barriers 176 are swung away from the terminal doorway 120 and positioned to permit the passengers P to access the hallway 122. The barrier actuators 174 may be controlled by the controller 152 to selectively permit or prevent access to the hallway 122 by a passenger P.

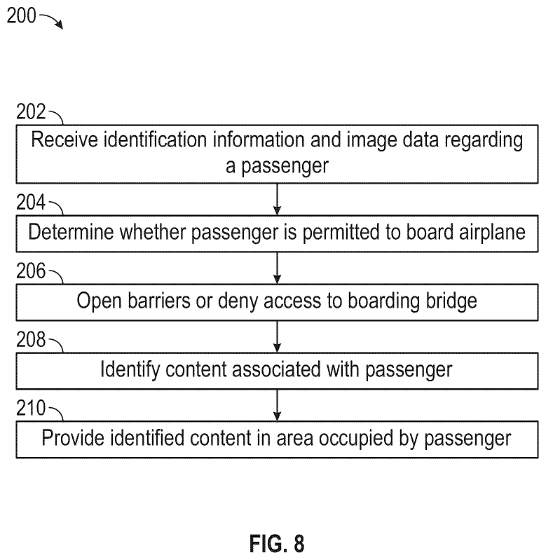

Referring to FIG. 8, a method 200 of operating the gate control system 150 is shown according to an exemplary embodiment. For conciseness of description, the processing and control steps of the method 200 are described as being performed by the controller 152. However, it should be understood that actions performed by the controller 152, by the beacon 24, or by the server 50, may be distributed across multiple devices. By way of example, the controller 152 may retrieve information required to make a determination from the server 50. By way of another example, the controller 152 may provide data to the server 50 for processing, and the server 50 may instruct the controller 152 to control the airport gate 100 based on the provided data.

In step 202 of the method 200, the controller 152 receives identification information and identity data (e.g., image data, sound data, etc.) regarding the passenger P. By way of example, the controller 152 may determine that the passenger P is approaching the terminal doorway 120. Such an approach may indicate that the passenger P wishes to board the airplane 14. The presence of the passenger P may be detected, for example, using an occupant sensor 166 positioned in front of the terminal doorway 120. Alternatively, personnel (e.g., a gate agent GA as shown in FIG. 6) may manually indicate when the passenger P is approaching the terminal doorway 120 (e.g., through an input on a user device 22). In response to detecting the presence of the passenger P, the gate control system 150 may activate the identity sensors 160 to capture identity data of the passenger P and/or prompt the passenger P to scan their credential 164 with the scanner 162. By way of example, the controller 152 may activate the display 170 and/or the speaker 172 to prompt the passenger P to scan their credential 164.

In step 204 of the method 200, the controller 152 determines whether the passenger P is permitted to board the airplane 14. The controller 152 may analyze the identity data and the identification information associated with the passenger P to determine whether the passenger P is permitted to board the airplane 14. The controller 152 may perform one or more checks, requiring all of the checks to pass before allowing the passenger P to board. If the passenger P fails one or more of the checks, the controller 152 may determine that the passenger P is not permitted to board the airplane 14.

By way of example, the controller 152 may compare information known about the passenger P with flight information about the flight that is being boarded to determine whether the passenger P is permitted to board. The flight information may be predetermined (e.g., by a ticketing service or airline) and stored in a database (e.g., in the server 50). The flight information may include information regarding the identities of the passengers ticketed for that flight, the assigned seats and boarding groups of the passengers, departure and arrival times, and departure and arrival locations, among other information.

The controller 152 may compare the identification information retrieved from the credential 164 with the flight information. Alternatively, the controller 152 may use the identity data of the passenger P (e.g., captured by the identity sensors 160) and retrieve corresponding identification information from a database (e.g., stored in the server 50). The controller 152 may compare the identification information and the flight information to verify that the identification information (e.g., name, address, phone number, flight number, destination, etc.) matches one of the individuals scheduled to be on the flight. The controller 152 may compare the identification information, the flight information, and the current boarding status of the flight to verify that the individual is part of a boarding group that has already been called for boarding. If the passenger P fails any of these verifications, the controller 152 may determine that the passenger P is not permitted to board the airplane 14.

By way of another example, the controller 152 may verify that the identity data matches the identification information provided by the passenger P using the credential 164. The controller 152 may compare the identity data of the passenger P (e.g., a fingerprint, a face image, an iris image, a voice recording, etc.) with a database containing corresponding data of known individuals. The controller 152 may select an individual from the database for comparison based on the identification information. If the controller 152 determines that the identity data does not match the individual associated with the identification information, the controller 152 may determine that the passenger P is not permitted to board the airplane 14. This may indicate, for example, that the passenger P is attempting to board using a ticket that was purchased for another individual.

By way of another example, the controller 152 may analyze the identity data and/or the identification information to determine whether the passenger P is a known individual that is not permitted to board the airplane 14 (e.g., whether the passenger P is on a no fly list). The controller 152 may compare the identity data of the passenger P (e.g., a fingerprint, a face image, an iris image, a voice recording, etc.) and/or the provided identification information (e.g., from the credential 164) with a database of information associated with known individuals that are not permitted to fly. If the controller 152 determines that the identity data or the identification information matches one of the known individuals, the controller 152 may determine that the passenger P is not permitted to board the airplane 14. The controller 152 may additionally provide a notification to a user (e.g., through a user device 22) indicating that the passenger P is not permitted to board the airplane 14.

In step 206 of the method 200, the controller 152 opens the barriers 176 to permit boarding the airplane 14 or holds the barriers 176 closed to prevent boarding the airplane 14. The controller 152 may control operation (e.g., movement) of the barriers 176 by controlling the barrier actuators 174. If the controller 152 determines in step 204 that the passenger P is permitted to board, the controller 152 may control the barrier actuators 174 to open the barriers 176. Once the passenger P has passed beyond the barriers 176 and through the terminal doorway 120 (e.g., as verified by an occupant sensor 166), the controller 152 may again control the barrier actuators 174 to close the barriers 176. If the controller 152 determines in step 204 that the passenger P is not permitted to board, the controller 152 may control the barrier actuators 174 to hold the barriers 176 closed. The controller 152 may also provide a notification indicating the reason for boarding denial (e.g., through a display 170, a speaker 172, a user device 22, etc.).

In step 208 of the method 200, the controller 152 identifies content associated with the passenger P. The GSE coordination system 10 may store a database of customer profiles or advertising profiles (e.g., a customer profile database within the server 50) each associated with a different passenger P. The customer profile may indicate known or suspected information regarding the passenger P. The customer profile may include the identification information and advertising information. The advertising information may include interests of the passenger P and/or demographic information associated with the passenger P. By way of example, the interests may include hobbies of the passenger P (e.g., running, cycling, reading, knitting, hiking, collecting, etc.), types of media that the passenger P consumes (e.g., sports, movie genres, etc.), types of food and drinks that the passenger P enjoys, or other information regarding products or activities that the passenger P is known to utilize. The demographic information may include the age, gender, location of residence, income, education level, profession, or parent status of the passenger P, or other information associated with the passenger P. The customer profiles may be generated by and stored within the GSE coordination system 10 or provided by a third-party service (e.g., over the Internet).

The GSE coordination system 10 may store a database of content (e.g., a content database within the server 50) to be provided to passengers P. The content may include advertisements, instructions, maps, or other information that may be desirable to provide to the passengers P. The content may be visual (e.g., for display using the displays 170) and/or audible (e.g., provided using the speakers 172). By way of example, the content may include advertisements such as product or service recommendations, discounts, product reviews, customer testimonials, etc. The advertisements may include instructions for how and where to purchase the advertised product or service (e.g., an address, a location within an airport, a web address, etc.). By way of example, the instructions may include a seat assignment for the passenger P, a location of a baggage carousel where the passenger P can retrieve their luggage, an instruction to move forward or stop moving, etc. By way of example, the maps may include airport maps, airplane seat maps, maps directing the passenger P to their hotel, etc. The content may be generated by and stored within the GSE coordination system 10 or provided by a third-party service (e.g., over the Internet).

The content database may associate each piece of content with particular identification information or advertising information. By way of example, the content database may associate advertisements for particular products or services with the interests of the passenger P (e.g., advertising helmets for passengers known to have cycling as an interest, advertising an upcoming horror movie to a passenger known to purchase tickets to horror movies, etc.). By way of another example, the content database may associate advertisements for particular products or services with particular demographics (e.g., advertising baby formula to new parents, advertising colleges to teenage passengers, etc.). By away of another example, the content database may generate instructions or maps based on the identification information (e.g., generating a seat map identifying the passenger's seat based on the identification information).

Using the identity data and/or the identification information, the controller 152 may identify a content profile associated with the passenger P. The controller 152 may then select content from the content database that is associated with parts of the content profile. If multiple pieces of content are identified, the controller 152 may cycle through the identified content over time.

In step 210 of the method 200, the controller 152 provides the identified content in an area occupied by the passenger P. The controller 152 may control the displays 170 and/or the speakers 172 to provide the identified content. Accordingly, the content may be provided visually and/or audibly.

As shown in FIG. 5, a queue of passengers P may form within the boarding bridge 110 when boarding or deplaning. Accordingly, it may be desirable to provide multiple different pieces of content tailored to the different passengers P. The airport gate 100 contains multiple displays 170 and speakers 172 spaced at intervals along the boarding bridge 110. Accordingly, the controller 152 may control the displays 170 and/or the speakers 172 to provide content based on the identities of the nearby passengers P. Using the identity sensors 160 and/or the occupant sensors 166, the controller 152 may track the locations of the passengers P as the passengers P move throughout the airport gate 100. The locations of the displays 170 and the speakers 172 may be predetermined and stored by the controller 152. The controller 152 may compare the locations of the passengers P and select the content for each display 170 and/or speaker 172 based on the content most appropriate for the nearest passenger P.

It should be understood that steps 202, 208, and 210 of the method may be performed when boarding and when deplaning. The identity sensors 160 may be positioned at each end of the boarding bridge 110 to permit identifying the passengers P coming through the boarding bridge 110 in either direction.

As utilized herein with respect to numerical ranges, the terms “approximately,” “about,”“substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the GSE coordination system 10 and the components thereof as shown in the various exemplary embodiments is illustrative only. Additionally, any element disclosed in one embodiment may be incorporated or utilized with any other embodiment disclosed herein.

1. An airport gate system, comprising:
a bridge having a first end and a second end opposite to the first end, wherein the second end is configured to be coupled to an airplane, and wherein the bridge is configured to permit access to a door of the airplane;
a barrier assembly configured to selectively limit movement of a passenger along the bridge;
a sensor configured to acquire data regarding the passenger; and
a controller operatively coupled to the barrier assembly and the sensor, the controller configured to:
determine whether the passenger is permitted to board the airplane based on the data; and
in response to a determination that the passenger is not permitted to board the airplane, control the barrier assembly to limit the movement of the passenger along the bridge.

2. The airport gate system of claim 1, wherein the sensor is a scanner, wherein the data is identification information retrieved by the scanner from a credential associated with the passenger, and wherein the controller is configured to compare the identification information with flight information to determine whether the passenger is permitted to board the airplane.

3. The airport gate system of claim 1, wherein the sensor is an identity sensor configured to capture identity data regarding the passenger, the identity sensor including at least one of a camera or a biometric sensor.

4. The airport gate system of claim 3, wherein the controller is configured to retrieve identification information based on the identity data, and wherein the controller is configured to compare the identification information with flight information to determine whether the passenger is permitted to board the airplane.

5. The airport gate system of claim 3, further comprising a scanner configured to retrieve identification information from a credential associated with the passenger, wherein the controller is configured to compare the identification information with the identity data to determine whether the passenger is permitted to board the airplane.

6. The airport gate system of claim 1, wherein, in response to a determination that the passenger is permitted to board the airplane, the controller is configured to control the barrier assembly to allow movement of the passenger along the bridge.

7. The airport gate system of claim 6, further comprising a display operatively coupled to the controller and positioned to be visible to a passenger passing along the bridge, wherein the controller is configured to identify a customer profile of the passenger based on the data, and wherein the controller is configured to control the display to present content based on the customer profile.

8. The airport gate system of claim 7, further comprising at least one occupant sensor operatively coupled to the controller and positioned within the bridge, wherein the at least one occupant sensor is configured to detect a position of the passenger along the bridge, and wherein the controller is configured to control the display to present the content based on the position of the passenger along the bridge.

9. An airport gate system comprising:
a bridge configured to permit access to a door of an airplane;
a display coupled to the bridge and positioned to be visible to a passenger passing along the bridge;
a sensor configured to acquire data regarding the passenger; and
a controller operatively coupled to the display and the sensor and configured to:
identify a customer profile of the passenger based on the data; and
control the display to present content based on the customer profile of the passenger.

10. The airport gate system of claim 9, wherein the controller is configured to determine whether the passenger is permitted to board the airplane based on the data.

11. The airport gate system of claim 10, wherein the sensor is a scanner, and wherein the data is identification information retrieved by the scanner from a credential associated with the passenger.

12. The airport gate system of claim 10, wherein the sensor is a camera or a biometric sensor.

13. The airport gate system of claim 10, further comprising a barrier assembly, wherein the controller is configured to:
control the barrier assembly to limit movement of the passenger along the bridge in response to a determination that the passenger is not permitted to board the airplane; and
control the barrier assembly to allow movement of the passenger along the bridge in response to a determination that the passenger is permitted to board the airplane.

14. The airport gate system of claim 10, further comprising at least one occupant sensor operatively coupled to the controller and positioned within the bridge, wherein the at least one occupant sensor is configured to detect a position of the passenger along the bridge.

15. The airport gate system of claim 14, wherein the controller is configured to control the display to present the content based on the position of the passenger along the bridge.

16. An airport gate system comprising:
a terminal section;
a bridge extending outward from the terminal section, wherein the bridge is configured to permit access to a door of an airplane;
a barrier assembly coupled to the terminal section and configured to selectively limit movement of a passenger along the bridge;
a sensor configured to acquire data regarding the passenger; and
a controller operatively coupled to the barrier assembly and the sensor, wherein the controller is configured to:
determine whether the passenger is permitted to board the airplane based on the data; and
in response to a determination that the passenger is permitted to board the airplane, control the barrier assembly to permit movement of the passenger along the bridge.

17. The airport gate system of claim 16, wherein, in response to a determination that the passenger is not permitted to board the airplane, the controller is configured to control the barrier assembly to limit movement of the passenger along the bridge.

18. The airport gate system of claim 16, further comprising a display coupled to the bridge and positioned to be visible to the passenger passing along the bridge, wherein the controller is configured to control the display to present content based on the data.

19. The airport gate system of claim 18, further comprising at least one occupant sensor operatively coupled to the controller and positioned within the bridge, wherein the at least one occupant sensor is configured to detect a position of the passenger along the bridge, and wherein the controller is configured to control the display to present the content based on the position of the passenger along the bridge.

20. The airport gate system of claim 16, wherein:
the sensor includes at least one of a camera or a biometric sensor configured to capture identity data regarding the passenger;
the controller is configured to retrieve identification information based on the identity data; and
the controller is configured to compare the identity data with the identification information to determine whether the passenger is permitted to board the airplane.
